(19) United States
(12) Patent Application Publication
(10) Pub. No.: US 2023/0375354 A1
(43) Pub. Date: Nov. 23, 2023

(54) METHOD, COMPUTER PROGRAM, AND DEVICE FOR MODIFYING A ROUTE

(71) Applicants: VOLKSWAGEN AKTIENGESELLSCHAFT, Wolfsburg (DE); AUDI AG, Ingostadt (DE)

(72) Inventors: Sorel LOUM, Berne (DE); Kai ECKRATH, Ingolstadt (DE); Simon DANNER, Munich (DE)

(21) Appl. No.: 18/248,297

(22) PCT Filed: Oct. 14, 2021
(86) PCT No.: PCT/EP2021/078445

§ 371 Date: Apr. 7, 2023

(30) Foreign Application Priority Data
Oct. 14, 2020 (DE) 10 2020 212 966.5

(51) Int. Cl. G01C 21/34; G01C 21/36

(52) U.S. Cl. CPC G01C 21/3484; G01C 21/3461; G01C 21/3664

(57) ABSTRACT

A method, computer program with instructions, and device for modifying a route for a transportation vehicle having an automated driving function. Also disclosed are a user interface for use in a method and a transportation vehicle in which a method or a device is used. Information regarding route sections of the route is provided by a user interface. A user input for modifying a start time or an end time of a route section that is drivable under supervision is received. The route is then modified in response to the user input.

### PRIORITY CLAIM

This patent application is a U.S. National Phase of International Patent Application No. PCT/EP2021/078445, filed 14 Oct. 2021, which claims priority to German Patent Application No. 10 2020 212 966.5, filed 14 Oct. 2020, the disclosures of which are incorporated herein by reference in their entireties.

### SUMMARY

Illustrative embodiments relate to a method, a computer program comprising instructions, and a device for adjusting a route for a transportation vehicle with an automated driving function. Illustrative embodiments further relate to a user interface for use in such a method, as well as a transportation vehicle, in which a disclosed method or a disclosed device is employed.

### BRIEF DESCRIPTION OF THE DRAWINGS

Further features of the disclosed embodiments are described in more detail below with reference to the figures, in which:

FIG. 1 schematically shows a method for adjusting a route for a transportation vehicle with an automated driving function;

FIG. 2 shows a first exemplary embodiment of a device for adjusting a route for a transportation vehicle with an automated driving function;

FIG. 3 shows a second exemplary embodiment of a device for adjusting a route for a transportation vehicle with an automated driving function;

FIG. 4 schematically represents a transportation vehicle, in which a disclosed solution is realized;

FIG. 5 shows a user interface for use in a disclosed method;

FIG. 6 shows the user interface of FIG. 5 according to the extension of a route section that can be driven under supervision;

FIG. 7 shows the user interface of FIG. 5 according to the shifting of a route section that can be driven under supervision; and

FIG. 8 shows a user interface for the adding of side activities.

### DETAILED DESCRIPTION

Automated driving, also denoted as autonomous driving or piloted driving, is the movement of transportation vehicles, mobile robots and driverless transport systems, which are largely autonomous. There are various degrees of automated driving. In Europe various ministries of traffic, for instance, in Germany the “Bundesanstalt für Straßenwesen”, have defined the following automation levels:
Level 0: “Only Driver”, the driver drives, steers, accelerates, brakes, etc. himself or herself.
Level 1: Certain assistance systems, including a speed regulation system such as ACC (Automatic Cruise Control), assist in the operation of the transportation vehicle.
Level 2: Partial automation. Therein automatic parking, lane-keeping, general longitudinal guidance, acceleration, deceleration etc. are taken over by assistance systems, including the avoidance of collisions.
Level 3: High level of automation. The driver need not constantly monitor the system The transportation vehicle performs functions, such as triggering the indicator, the lane change and the lane guidance independently. The driver may address other issues, however, upon request has to take over control within an advance warning time.
Level 4: Complete automation. The guidance of the transportation vehicle is permanently taken over by the system. If the system is no longer in a position to cope with the tasks, the driver may be asked to take over control.
Level 5: No driver required. Apart from setting the target and starting the system, no human intervention is required.

In high-level automated driving of level 3 the driver is granted the possibility of performing non-driving secondary activities. Since, however, only certain route sections can be driven in a piloted manner, the route sections which can be driven in a piloted manner frequently do not match the planned activities of the driver. The benefits of the automated driving function might therefore not be optimally used.

Against this background, the U.S. Pat. No. 9,582,004 B2 describes a method for predicting a time available for autonomous driving in a transportation vehicle. In the method, the time available for autonomous driving based on a planned route and transportation vehicle surrounding information, transportation vehicle dynamics parameters, map data with associated speed limiting and infrastructure information, real-time traffic information and/or real-time weather information associated with the planned route is calculated. Moreover, a transition time required for transitioning from autonomous to manual driving is calculated and included in the calculation of the time available for autonomous driving. The calculated time available for autonomous driving along the planned route is output to a human machine interface arranged in a passenger compartment of the transportation vehicle.

U.S. Pat. No. 9,904,286 B2 describes a method for operating a transportation vehicle comprising an automatic mode and a manual mode. In the method, an operation of the transportation vehicle can be changed in such a way that a transition time, at which a transition from the automatic mode to the manual mode occurs, is delayed in such a way that a period of time of driving in the automatic mode is extended. For this purpose a user interface is provided, which offers the user a choice of possible options.

DE 10 2013 008 605 A1 describes a method for operating a navigation system for a transportation vehicle with autopilot, wherein the autopilot is configured to automatically perform a longitudinal and lateral guidance of the transportation vehicle in the activated state during a piloted driving without any intervention of a driver. In the method by the navigation system as to a set target of the user on the basis of navigation data a driving route towards the target is determined. On the basis of traffic data and on the basis of a predetermined activation condition for the autopilot it is determined, on which roads the activating of the autopilot is presumably possible. In the method, the user can provide specifications as to the piloted driving.

Disclosed embodiments provide improved solutions for adjusting a route for a transportation vehicle with an automated driving function.

This task is solved by a method, by a computer program comprising instructions, by a device, as well as by a user interface.

According to a first disclosed embodiment, a method for adjusting a route for a transportation vehicle with an automated driving function comprises:
providing information as to sections of the route by a user interface;
receiving a user input for adjusting a duration, a starting time, or an end time of a route section that can be driven in a piloted manner; and
adjusting the route in response to the user input.

According to a further disclosed embodiment, a computer program comprises instructions, which, when they are executed by a computer cause the computer to execute the following operations for adjusting a route for a transportation vehicle with an automated driving function.
providing information as to route sections by a user interface;
receiving a user input for adjusting a duration, a starting time, or an end time of a route section that can be driven in a piloted manner; and
adjusting the route in response to the user input.

The term computer in this connection is to be taken in a wide sense. In particular, it also comprises control devices, embedded systems, and other processor-based data processing devices.

The computer program may, for instance, be provided for an electronic retrieval or be stored on a computer-readable storage medium.

According to a further disclosed embodiment, a device for adjusting a route for a transportation vehicle with an automated driving function comprises:
a graphics module for providing information as to sections of the route by a user interface;
an input module for receiving a user input for adjusting a duration, a starting time, or an end time of a route section that can be driven in a piloted manner; and
a planning module for adjusting the route in response to the user input.

According to a further disclosed embodiment, a user interface for use in a method for adjusting a route for a transportation vehicle comprises information as to sections of the route and at least one graphical operating element for adjusting a duration, a starting time, or an end time of a route section that can be driven in a piloted manner.

Frequently the sections of a route that can be driven in a piloted manner, in particular, duration and starting time of the route sections that can be driven in a piloted manner, do not match the planned activities of the user of a transportation vehicle. For example, a video conference might take 20 minutes longer than the driving of a route section that can be driven in a piloted manner. A further example is the live transmission of a soccer match starting already a few minutes prior to reaching a route section that can be driven in a piloted manner. In the case of the disclosed solution, the user is therefore provided with a user interface, by which he or she can easily adjust parameters of the route sections that can be driven in a piloted manner. In particular, an adjustment of duration, starting time, or end time of a route section that can be driven in a piloted manner is facilitated. In this way, the user can adjust the route easily to his or her planned side activities.

According to an exemplary embodiment, the information as to the sections of the route are provided as a timeline. The representation as timeline is particularly clear to the user. The timeline conveys in a very easily interpretable way when on which route sections how much time is available for non-driving activities.

According to an exemplary embodiment, the user input is effected by shifting a graphical operating element of the user interface. The shifting of graphical operating elements is clearly more comfortable for the user than the input of values via a keyboard. Moreover, users are used to such kind of operation of touch-sensitive user interfaces so that an intuitive operation is ensured.

According to an exemplary embodiment, for adjusting the route an arrival time or an average speed for at least one route section is changed. A highly automated driving function, such as, for example, a highway pilot, normally drives at a maximum speed of 130 km/h. For this speed, however, there is a certain tolerance. For more time to be available for non-driving activities, for instance, the average speed may be reduced and thereby the driving time with pilot assistance be extended. For this purpose, the user interface grants the user the possibility to extend a route section that can be driven in a piloted manner. The reduction of the average speed required for the reduction may, for instance, also be effected by the input of an average speed by the user. Alternatively, the user may also predetermine a changed duration of the period of piloted driving or a changed arrival time, from which then a changed average speed is calculated. The user interface may alternatively or additionally grant the user the possibility to reach a route section that can be driven in a piloted manner at a changed point in time. In this case, an adjusted average speed during a preceding period of manual driving is suggested to the user.

The possibility to use a transportation vehicle as mobile office and space for relaxation will probably result in the fastest possible arrival no longer being the main objective in every situation. To be able to engage in certain side activities, probably many users will take on board a lower average speed and a later arrival time as a result.

According to an exemplary embodiment, upon changing the average speed for a route section boundary conditions for the route sections are considered. As soon as the user adjusts a route section that can be driven in a piloted manner, an algorithm calculates to which extent average velocities and arrival time need to be adjusted. The algorithm moreover determines the range in which the user may make changes. The reduction of the average speed should only be effected to a reasonable extent, in which neither traffic security is impaired, nor the traffic flow disrupted. For this purpose the algorithm may, for instance, consider the individual piloted and manually driven route sections, the maximum speeds of the individual route sections or the minimal speeds on the individual route sections. The maximum and minimum velocities result, for instance, from the kind of road, the density of traffic, curve radii, etc. In particular, for predictive suggestions moreover duration and starting time of planned side activities may be considered.

According to an exemplary embodiment, by the user interface information as to at least one non-driving activity in relation to the route is provided. For the user interface to offer a faster possibility of comparing non-driving activities and route sections that can be driven in a piloted manner, side activities, such as video conferences, films or live transmissions, may be represented together with the route sections that can be driven in a piloted manner, optionally on a common timeline. This representation makes it easier for the user to compare side activities and route sections that can be driven in a piloted manner and to plan the route according to their individual needs. Moreover, the user interface facilitates adding further activities. As far as the activities do not have a fixed starting time, such as, for instance, live transmissions or appointments, these may be shifted as desired on the timeline. In case the planned activities of the user do not match the route sections that can be driven in a piloted manner, the system may calculate a suitable adjustment of the route sections that can be driven in a piloted manner and submit predictive suggestions to the user.

Particularly beneficial, a disclosed method or a disclosed device are inserted into a partially autonomously controlled transportation vehicle. The transportation vehicle may be a motor vehicle, but also a ship, an aircraft, for example, a volocopter, etc.

For the sake of better understanding of the principles of the present disclosure, the following exemplary embodiments are explained in more detail by reference to the figures. It goes without saying that the disclosure is not limited to these embodiments and that the described features may also be combined or modified, without departing from the protective scope of the disclosure.

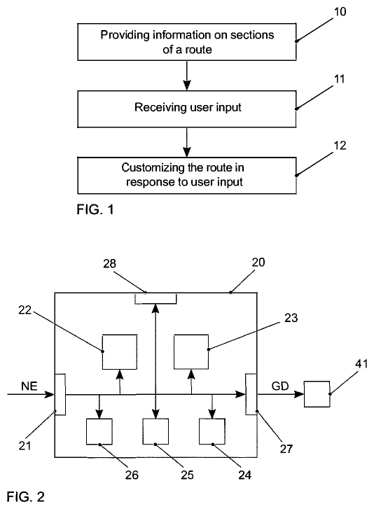

FIG. 1 shows schematically a method for adjusting a route for a transportation vehicle with an automated driving function. In a first operation information as to the sections of the route are provided by a user interface 10, for instance, as a timeline. Moreover, by the user interface information as to the at least one non-driving activity in relation to the route may be provided. Subsequently, a user input for adjusting a duration, a starting time, or an end time of a route section that can be driven in a piloted manner is received 11. The user input may, for instance, be effected by shifting a graphical operating element of the user interface. In response to the user input, then the route is adjusted 12. For this purpose, for instance, an arrival time or an average speed may be changed for at least one route section. Optionally, when changing the average speed boundary conditions are considered.

FIG. 2 shows a simplified schematic representation of a first exemplary embodiment of a device 20 for adjusting a route for a transportation vehicle with an automated driving function. The device 20 has an input 21, via which, for instance, user inputs NE may be received. A graphics module 22 is configured to provide information as to sections of the route by a user interface, for instance, as a timeline. Moreover, the graphics module 22 by the user interface may provide information as to at least one non-driving activity in relation to the route. For this purpose, corresponding graphics data GD may be output via an output 27 of the device 20 to a display device 41. An input module 23 is configured to receive a user input NE for adjusting a duration, a starting time, or an end time of a route section that can be driven in a piloted manner. The user input NE may, for example, be effected by shifting a graphical operating element of the user interface. A planning module 24 is configured to adjust the route in response to the user input NE. For this purpose, the planning module 24 may, for instance, change an arrival time or an average speed for at least one route section. Optionally, the planning module 24 considers boundary conditions for the respective route section when changing the average speed. The graphics module 22 subsequently adjusts the provided information accordingly to the sections of the route.

The graphics module 22, the input module 23, and the planning module 24 may be controlled by a control module 25. Via a user interface 28, if necessary, settings of the graphics module 22, of the input module 23, of the planning module24, or of the control module 25 may be changed. The data accruing in the device 20 may be deposited in a memory 26, if required, for instance, for a later evaluation or for a use by the components of the device 20. The graphics module 22, the input module 23, the planning module 24, as well as the control module 25 may be realized as dedicated hardware, for instance, as integrated circuits. Of course, however, they may also be partly or completely combined or implemented as software running on a suitable processor, for instance, on a GPU or a CPU. The input 21 and the output 27 may be implemented as separate interfaces or as a combined bidirectional interface.

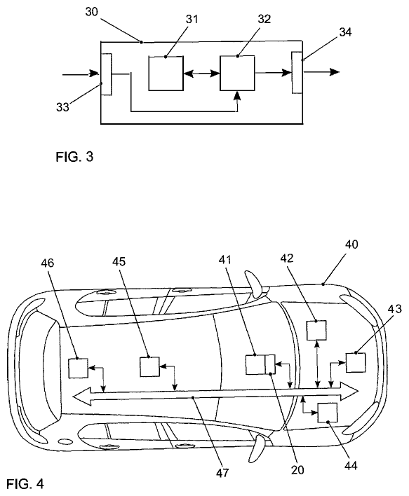

FIG. 3 shows a simplified schematic representation of a second exemplary embodiment of a device 30 for adjusting a route for a transportation vehicle with an automated driving function. The device 30 comprises a processor 32 and a memory 31. For instance, the device 30 is a computer or a control device. In the memory 31 instructions are deposited, which, when they are executed by the processor 32, cause the device 30 to carry out the operations according to one of the described methods. The instructions deposited in the memory 31 thus embody a program, which can be executed by the processor 32 and which the disclosed method realizes. The device 30 has an input 33 for receiving information, for instance, user inputs. Data generated by the processor 32 are provided via an output 34. Moreover, they may be deposited in the memory 31. The input 33 and the output 34 may be combined to a bidirectional interface.

The processor 32 may comprise one or several processor units, for instance, microprocessors, digital signal processors or combinations thereof.

The memories 26, 31 of the described embodiments may comprise both volatile as well as non-volatile memory regions and comprise the most varied memory devices and memory media, for instance, hard disks, optical memory media, or semi-conductor memories.

FIG. 4 schematically represents a transportation vehicle 40, in which a disclosed solution is realized. The transportation vehicle 40 in this example is a transportation vehicle. The transportation vehicle comprises at least one display device 41, for example, a display of an infotainment system installed in the dashboard. Moreover, the transportation vehicle comprises a device 20 for adjusting a route. This is represented in FIG. 4 as separate device 20, however, may also be integral part of the display device 41 or a different component of the transportation vehicle. An assistance system 42 is configured to realize at least on individual route sections an automated driving function, in which the transportation vehicle drives with pilot assistance and in which the user may dedicate themselves to non-driving activities. For this purpose, the assistance system 42 may resort to data of a sensor system 43 or a navigation system 44. By a data transmission unit 45 a connection to service providers or other transportation vehicles may be established. For storing data, a memory 46 is present. The exchange of data between the various components of the transportation vehicle is effected via a network 47.

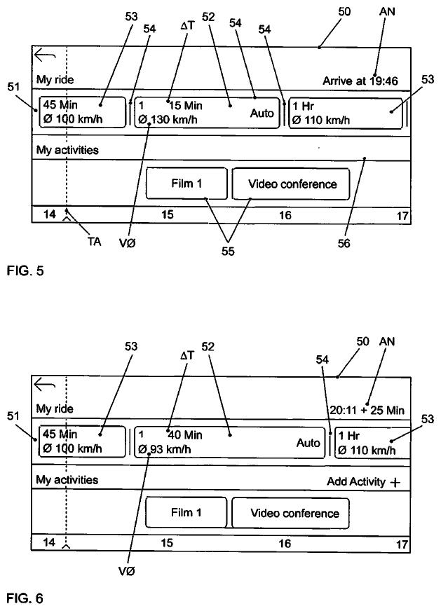

FIG. 5 shows a user interface 50 for use in a disclosed method, which in this example is represented on a display of an infotainment system. In the user interface 50, the currently driven or planned route 51 is represented as a timeline. The route 51 in this example comprises a route section 52 that can be driven in a piloted manner as well as two route sections 53 that are to be driven manually. For each of the route sections 52, 53 a duration ΔT as well as an average speed VØ to be driven is indicated. Equally shown are an indicator for the current time TA as well as the estimated arrival time AN. Between the route sections 52, 53 graphical operating elements 54 are arranged, in which the starting time or end time of the route sections 52, 53 can be manipulated. Also the frames arranged around the route sections 52, 53 serve as graphical operating element 54, by which the respective route section 52, 53 can be shifted. Below the route 51 along the timeline symbols for the planned non-driving activities 55 are arranged. In FIG. 5 two non-driving side activities 55, a reproduction of a film, as well as a video conference are exemplarily represented. By a further graphical operating element 56 further non-driving side activities may be added.

FIG. 6 shows the user interface 50 from FIG. 5 after the extension of the route section 52 that can be driven in a piloted manner. Via the graphical operating element 54 arranged to the right of the route section 52 that can be driven in a piloted manner the user has shifted the end time of the route section 52 that can be driven in a piloted manner by 25 minutes and thus extended the duration ΔT by 25 minutes. Accordingly, the average speed VØ in the route section 52 that can be driven in a piloted manner is reduced. The arrival time AN shifts accordingly backwards.

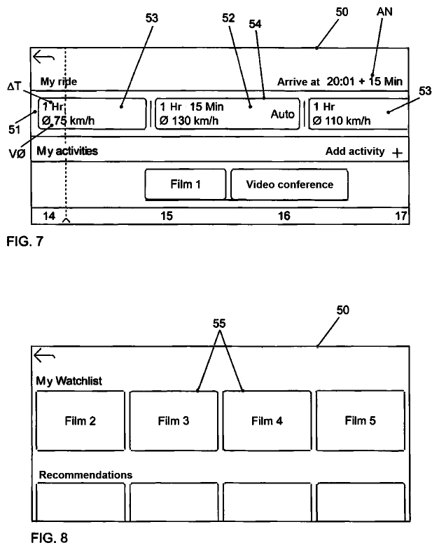

FIG. 7 shows the user interface 50 from FIG. 5 after the shifting of the route section 52 that can be driven in a piloted manner. By using the frame of the route section 52 that can be driven in a piloted manner as graphical operating element 54 the user has shifted the route section 52 that can be driven in a piloted manner by 15 minutes, that is the route section 52 that can be driven in a piloted manner is reached 15 minutes later. Accordingly, the duration ΔT of the previous route section 53 that is to be driven manually is extended by 15 minutes. For this purpose the average speed VØ in this route section 53 is reduced, that is in the course of the navigation a new recommended average speed is suggested to the user. Also in this case the arrival time AN is shifted backwards.

FIG. 8 shows the user interface 50 for the adding of side activities. By activating the graphical operating element 56 for the adding of side activities a new operating surface is opened, in which possible side activities 55 may be selected. Upon selecting a side activity 55 this is added to the timeline and, if need be, may then be shifted there.

In the above-described example, the user interface 50 is represented on a display of an infotainment system. Optionally, the user interface 50 additionally is also available as smartphone or web application. Hereby, the driver may plan his route in advance, adjust it during breaks or the automated driving, or also have it adjusted by the co-driver during a manual driving. This may improve the user experience by additional flexibility.

### REFERENCE SIGNS

10 providing information as to sections of a route
11 receiving a user input
12 adjusting the route in response to the user input
20 device
21 input
22 graphics module
23 input module
24 planning module
25 control module
26 memory
27 output
28 user interface
30 device
31 memory
32 processor
33 input
34 output
40 transportation vehicle
41 display device
42 assistance system
43 sensor system
44 navigation system
45 data transmission unit
46 memory
47 network
50 user interface
51 route
52 piloted drivable route section
53 route section to be driven manually
54 graphical operating element
55 non-driving activity
56 graphical operating element
An arrival time
ΔT duration
GD graphics data
NE user input
TA current time
VØ average speed

1. A method for adjusting a route for a transportation vehicle having an automated driving function, the method comprising:
outputting information corresponding to sections of a route by a user interface;
receiving a user input for adjusting a starting time or an end time of a route section to be driven under supervision; and
adjusting the route in response to the user input.

2. The method of claim 1, wherein the information corresponds to the sections of the route are output by the user interface as a timeline.

3. The method of claim 1, wherein the user input is effected by shifting a graphical operating element of the user interface.

4. The method of claim 1, wherein, for adjusting the route, an arrival time or an average speed for at least one route section is changed.

5. The method of claim 4, wherein, in response to changing the average speed for a route section, boundary conditions for the route section are considered.

6. The method of claim 1, further comprising the user interface outputting information about at least one non-driving activity in relation to the route.

7. A non-transitory computer readable medium including a computer program comprising instructions, which, when executed by a computer, cause the computer to perform the method of claim 1 for adjusting a route for a transportation vehicle having an automated driving function.

8. A device for adjusting a route for a transportation vehicle with an automated driving function, comprising:
a graphics module for outputting information corresponding to sections of the route via a user interface;
an input module for receiving a user input for adjusting a starting time or an end time of a route section to be driven under supervision; and
a planning module for adjusting the route in response to the user input.

9. A user interface for use in for adjusting a route for a transportation vehicle, wherein the user interface comprises:
information about sections of the route; and
at least one graphical operating element for adjusting a starting time or an end time of the route section to be driven under supervision.

10. A transportation vehicle, comprising the device of claim 8.

11. The device of claim 8, wherein the information corresponds to the sections of the route are output by the user interface as a timeline.

12. The device of claim 8, wherein the user input is effected by shifting a graphical operating element of the user interface.

13. The device of claim 8, wherein, for adjusting the route, an arrival time or an average speed for at least one route section is changed.

14. The device of claim 13, wherein, in response to changing the average speed for a route section, boundary conditions for the route section are considered.

15. The device of claim 8, wherein information about at least one non-driving activity in relation to the route is output by the user interface.
